(19) United States
(12) Patent Application Publication
(10) Pub. No.: US 2024/0088732 A1
(43) Pub. Date: Mar. 14, 2024

(54) COMPOSITE MATERIAL PERMANENT MAGNET SYNCHRONOUS MOTOR

(71) Applicant: Beijing Chuangxing Yangguang Technology Development Co., Ltd., Beijing (CN)

(72) Inventor: Ranjun LI, Deyang City (CN)

(21) Appl. No.: 18/512,091

(22) Filed: Nov. 17, 2023

Related U.S. Application Data
(63) Continuation of application No. PCT/CN2021/118442, filed on Sep. 15, 2021.

(30) Foreign Application Priority Data
May 31, 2021 (CN) 2021105974842

(51) Int. Cl. H02K 1/2786; H02K 5/02; H02K 9/19

(52) U.S. Cl. CPC H02K 1/2786; H02K 5/02; H02K 9/19; H02K 2201/03

(57) ABSTRACT

A composite material permanent magnet synchronous electric motor includes a composite material shell; a permanent magnet outer rotor is disposed in the composite material shell; a stator is disposed in the permanent magnet outer rotor in a penetrating manner; and air gaps are disposed in gaps between the stator and the composite material shell and between the stator and the permanent magnet outer rotor in a one-to-one correspondence manner. The composite material permanent magnet synchronous motor improves an output torque of a motor with a same power, improves a power-to-weight ratio of the electric motor, and improves a power density; and by means of using composite materials, weights of the permanent magnet synchronous motor are reduced, and a mechanical strength thereof is improved.

### TECHNICAL FIELD

The disclosure relates to a field of synchronous motor technology, in particular to a composite material permanent magnet synchronous motor.

### BACKGROUND

A traditional outer rotor brushless motor is greatly limited in an installation and an application due to a rotor component being installed on an outside. Due to a structure that the rotor component is installed on the outside, a surrounding space is required to be large and safety protection requirements are high. The traditional outer rotor brushless motor cannot be made of a metal material for a shell, as cutting of magnetic field lines by the metal material can generate eddy currents that cause the shell to heat up, and a high temperature causes permanent magnets to demagnetize, ultimately leading to reduce a motor performance or make a motor fail. In addition, an installation method is affected by the above structure and the rotor component only is fixed at a lower part of the stator.

### SUMMARY

### Technical Problem

Disadvantages of an inner rotor brushless motor are as follows.
(1) Due to a rotor core being inside a stator, a heat dissipation performance of a rotor is poor.
(2) In motors with the same volume and weight, the inner rotor brushless motor has a small rotational torque.
(3) To meet output torque requirements, a reduction device is installed to increase the rotational torque. Owning to adding of the reduction device, production costs are increased, a weight of a power device is increased, the space is occupied more, product maintenance costs are increased, and a failure rate of a transmission structure is increased.

### Solution to the Problem

### Technical Solution

In response to the disadvantages of the related art, the disclosure provides a composite material permanent magnet synchronous motor, which solves the disadvantages raised in the related art.

To achieve objectives, the disclosure is implemented through a following technical solution. The composite material permanent magnet synchronous motor includes:
a composite material shell;
a permanent magnet outer rotor, disposed in the composite material shell; and
a stator, disposed in the permanent magnet outer rotor in a penetrating manner;
where gaps between the stator and the composite material shell and between the stator and the permanent magnet outer rotor are provided with air gaps in a one-to-one correspondence manner.

In an embodiment, the composite material shell is made of composite materials, and the composite materials comprise one or more of a carbon fiber, polyvinyl chloride (PVC), and acrylonitrile butadiene styrene (ABS).

In an embodiment, the motor further includes a power output shaft disposed in the stator. The power output shaft coincides with a central axis of the stator, an end of the power output shaft extends out of the composite material shell, and another end of the power output shaft extends out of a metal radiator.

In an embodiment, the motor further includes thermal conductive cores disposed on two ends of the stator, and the stator is fixedly connected to the thermal conductive cores.

In an embodiment, the stator defines a liquid flow channel.

In an embodiment, the motor further includes a metal bottom shell disposed on the composite material shell, and a connection part between the composite material shell and the metal bottom shell defines a plurality of threaded holes.

In an embodiment, the motor further includes a metal radiator disposed in the metal bottom shell, and the metal radiator is fixed with the metal bottom shell by bolts.

In an embodiment, a pipeline is disposed between the liquid flow channel and the metal radiator, and the stator is connected to the metal radiator through coordination of the liquid flow channel and the pipeline.

In an embodiment, a water outlet and a water inlet are disposed in an inner wall of the metal bottom shell.

### BENEFICIAL EFFECTS OF THE DISCLOSURE

### Beneficial Effects

The disclosure provides a composite material permanent magnet synchronous motor, which has the following beneficial effects.
1. Two air gaps are set in the composite permanent magnet synchronous motor. One air gap is located between the stator and the composite material shell, which allows the stator to be placed inside the composite material shell and provides a buffer space for the composite material shell to enhance a protective capacity of the composite material shell. The other air gap is located between the stator and the permanent magnet outer rotor, which is convenient for the permanent magnet outer rotor to rotate and cut magnetic field lines to generate eddy currents.
2. The composite permanent magnet synchronous motor uses the composite materials that provides the effective heat dissipation for an operation of internal components of the composite material shell, and reduces weights of the composite permanent magnet synchronous motor.
3. In the composite material permanent magnet synchronous motor, the stator obtains the effective heat dissipation through the thermal conductive cores. The liquid flow channel provides a flow channel for cooling liquid, allowing the liquid to flow inside the stator along the liquid flow channel, thereby providing an efficient heat dissipation treatment for the stator. Coordination of the metal radiator and the metal bottom shell provides an effective heat dissipation treatment for the internal components of the composite material shell. Liquid effectively provides a circulating heat dissipation treatment for the stator through the coordination of the liquid flow channel, the pipeline and the metal radiator, to maintain a temperature of the composite material permanent magnet synchronous motor within a suitable range for a long-term operation. Coordination of the water outlet and the water inlet effectively provides an inlet and an outlet for a liquid injection and a liquid discharge.
4. Compared to the related art, the disclosure increases the output torque of same power motors, increases the power to weight ratio of the motor, increases the power density. The disclosure uses composite materials to reduce the weight of the motor and increase a mechanical strength.
5. The disclosure uses advantages of the high rotational torque and the high power to weight ratio of an outer rotor motor, the outer rotor motor of a same size is 30% larger than an inner rotor motor due to a physical structure of the outer rotor motor.
6. The disclosure improves a stator base structure by making the composite materials into an outer shell of the motor, while non-metallic materials such as the carbon fiber, the PVC, and the ABS are made into the outer shell of the motor, providing a sufficient installation space for the internal components. The motor is installed in anywhere it needs to be installed, as a rotor part is installed internally and fully uses the advantages of a high external rotor torque and a power ratio.

### BRIEF DESCRIPTION OF DRAWINGS

FIG. 1 is a schematic diagram of a main view structure of a composite material permanent magnet synchronous motor according to an embodiment of the disclosure.

FIG. 2 is a schematic diagram of an outer side view structure of the composite material permanent magnet synchronous motor according to the embodiment of the disclosure.

FIG. 3 is a schematic diagram of an internal side view structure of the composite material permanent magnet synchronous motor according to the embodiment of the disclosure.

Description of reference numerals: 1. composite material shell; 2. stator; 3. thermal conductive core; 4. permanent magnet outer rotor; 5. air gap; 6. metal radiator; 7. water outlet; 8. water inlet; 9. threaded hole; 10. metal bottom shell; and 11. power output shaft.

### DETAILED DESCRIPTION OF EMBODIMENTS

The following provide a clear and complete description of a technical solution in embodiments of the disclosure, in conjunction with accompanying drawings. Apparently, the embodiments are only some of the embodiments of the disclosure, not all of the embodiments.

In the description of the disclosure, unless otherwise specified, a meaning of “multiple” refers to two or more; terms “up”, “down”, “left”, “right”, “inside”, “outside”, “front end”, “back end”, “head”, “tail”, etc. indicate one of an orientation relationship and a positional relationship as shown in the accompanying drawings, solely for a convenience of describing the disclosure and simplifying the description, rather than indicating or implying that a device or component referred to must have a specific orientation, be constructed and operated in the specific orientation, therefore it cannot be understood as a limitation of the disclosure. In addition, terms “first”, “second”, “third”, etc. are only used to describe a purpose and cannot be understood as indicating or implying a relative importance.

In the description of the disclosure, it should be noted that unless otherwise specified and limited, terms “connected”, “connection” should be understood in a broad sense, for example, it can be a fixed connection, a detachable connection, and an integrated connection; it can be a mechanical connection, an electrical connection; it can be a direct connection, an indirect connection through an intermediate medium. For those skilled in the art, a specific meaning of the terms in the disclosure can be understood in specific circumstances.

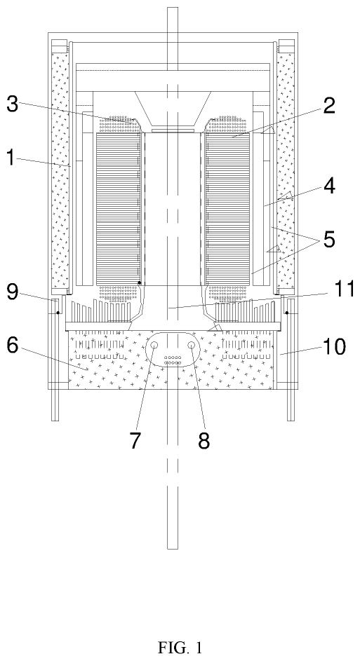

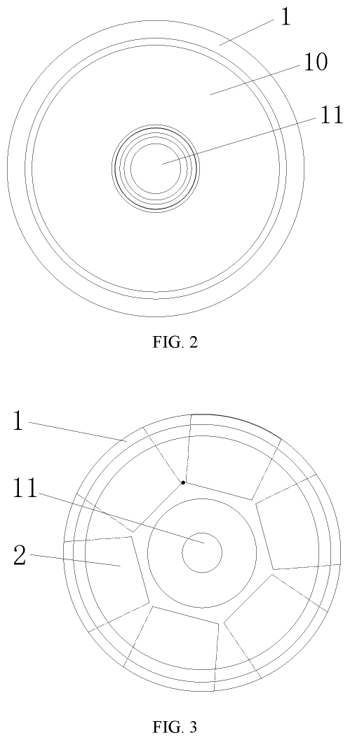

Referring to FIGS. 1-3, the disclosure provides a technical solution. A composite material permanent magnet synchronous motor includes: a composite material shell 1, a permanent magnet outer rotor 4 and a stator 2. The permanent magnet outer rotor 4 is disposed in the composite material shell 1, and the stator 2 penetrates through and is disposed in the permanent magnet outer rotor 4. Gaps between the stator 2 and the composite material shell 1 and between the stator 2 and the permanent magnet outer rotor 4 are provided with air gaps 5 in a one-to-one correspondence manner. Two air gaps 5 are provided, one air gap 5 is located between the stator 2 and the composite material shell 1, which allows the stator 2 to be placed inside the composite material shell 1 and provides a buffer space for the composite material shell 1 to enhance a protective capacity of the composite material shell 1. The other air gap 5 is located between the stator 2 and the permanent magnet outer rotor 4, which is convenient for the permanent magnet outer rotor 4 to rotate and cut magnetic field lines to generate eddy currents.

In an embodiment, the composite material shell 1 is made of composite materials, and the composite materials include one or more of a carbon fiber, polyvinyl chloride (PVC), and acrylonitrile butadiene styrene (ABS). A use of the composite materials provides an effective heat dissipation for an operation of internal components of the composite material shell 1 and reduces weights of the composite material permanent magnet synchronous motor.

In an embodiment, a power output shaft 11 is disposed in the stator 2, and the power output shaft coincides with a central axis of the stator 2. One end of the power output shaft 11 extends out of the composite material shell 1, and another end of the power output shaft 11 extends out of a metal radiator 6.

In an embodiment, thermal conductive cores 3 are disposed on two ends of the stator 2, and the stator 2 is fixedly connected to the thermal conductive cores 3. The stator 2 obtains the effective heat dissipation through the thermal conductive cores 3.

In an embodiment, a liquid flow channel is disposed in the stator 2, which provides a flow channel for cooling liquid, allowing the liquid to flow along the liquid flow channel inside the stator 2, thereby providing an efficient heat dissipation treatment for the stator 2.

In an embodiment, a metal bottom shell 10 is disposed on the composite material shell 1, and a plurality of threaded holes 9 are defined at a connection part between the composite material shell 1 and the metal bottom shell 10.

In an embodiment, a metal radiator 6 is disposed in the metal bottom shell 10, and the metal radiator 6 is fixed with the metal bottom shell 10 by bolts. Coordination of the metal radiator 6 and the metal bottom shell 10 provides an effective heat dissipation treatment for the internal components of the composite material shell 1.

In an embodiment, a pipeline is disposed between the liquid flow channel and the metal radiator 6, and the stator 2 is connected to the metal radiator 6 through coordination of the liquid flow channel and the pipeline. The liquid effectively provides a circulating heat dissipation treatment for the stator 2 through the coordination of the liquid flow channel, the pipeline, and the metal radiator 6, to maintain a long-term operating temperature of the motor within an appropriate range.

In an embodiment, an inner wall of the metal bottom shell 10 is provided with a water outlet 7 and a water inlet 8. Coordination of the water outlet 7 and the water inlet 8 effectively provides an inlet and an outlet for the liquid, making it easy to fill or discharge liquid.

In summary, the composite permanent magnet synchronous motor uses the composite materials to reduce its own weight when in use. The liquid is introduced into an interior of the metal radiator 6 through the water inlet 8, and the circulating heat dissipation treatment is effectively provided for the stator 2 through the coordination of the liquid flow channel, the pipeline, and the metal radiator 6, the long-term operating temperature of the motor is maintained within the appropriate range, and the efficient heat dissipation treatment is provided in the coordination with the thermal conductivity cores 3.

The above embodiments are only the preferred specific embodiments of the disclosure, but a scope of a protection of the disclosure is not limited to the disclosure. Any skilled in the art familiar with the technical field who, within the scope of the disclosed technology, making equivalent substitutions or modifications based on the technical solution and inventive concept of the disclosure should be covered within the scope of the protection of the disclosure.

What is claimed is:

1. A composite material permanent magnet synchronous motor, comprising:
a composite material shell (1);
a permanent magnet outer rotor (4), disposed in the composite material shell (1); and
a stator (2), disposed in the permanent magnet outer rotor (4) in a penetrating manner;
wherein gaps between the stator (2) and the composite material shell (1) and between the stator (2) and the permanent magnet outer rotor (4) are provided with air gaps (5) in a one-to-one correspondence manner.

2. The composite permanent magnet synchronous motor as claimed in claim 1, wherein the composite material shell (1) is made of composite materials, and the composite materials comprise one or more of a carbon fiber, polyvinyl chloride (PVC), and acrylonitrile butadiene styrene (ABS).

3. The composite permanent magnet synchronous motor as claimed in claim 1, comprising: a power output shaft (11) disposed in the stator (2), wherein the power output shaft (11) coincides with a central axis of the stator (2), an end of the power output shaft (11) extends out of the composite material shell (1), and another end of the power output shaft (11) extends out of a metal radiator (6).

4. The composite permanent magnet synchronous motor as claimed in claim 1, comprising:
thermal conductive cores (3) disposed on two ends of the stator (2), and the stator (2) being fixedly connected to the thermal conductive cores (3).

5. The composite material permanent magnet synchronous motor as claimed in claim 1, wherein the stator (2) defines a liquid flow channel.

6. The composite material permanent magnet synchronous motor as claimed in claim 1, comprising a metal bottom shell (10) disposed on the composite material shell (1), wherein a connection part between the composite material shell (1) and the metal bottom shell (10) defines a plurality of threaded holes (9).

7. The composite material permanent magnet synchronous motor as claimed in claim 6, comprising a metal radiator (6) disposed in the metal bottom shell (10), wherein the metal radiator (6) is fixed with the metal bottom shell (10) by bolts.

8. The composite permanent magnet synchronous motor as claimed in claim 5, wherein a pipeline is disposed between the liquid flow channel and the metal radiator (6), and the stator (2) is connected to the metal radiator through coordination of the liquid flow channel and the pipeline.

9. The composite material permanent magnet synchronous motor as claimed in claim 6, wherein an inner wall of the metal bottom shell (10) are provided with a water outlet (7) and a water inlet (8).

10. The composite material permanent magnet synchronous motor as claimed in claim 1, wherein one of the air gaps (5) is disposed between the permanent magnet outer rotor (4) and the composite material shell (1), and the other air gap (5) is disposed between the stator (2) and the permanent magnet outer rotor (4).

11. A composite material permanent magnet synchronous motor, comprising:
a composite material shell (1);
a permanent magnet outer rotor (4), disposed in the composite material shell (1); and a first air gap (5) is defined between the composite material shell (1) and the permanent magnet outer rotor (4);
a stator (2), disposed in the permanent magnet outer rotor (4); wherein the stator (2) defines a liquid flow channel, and a second air gap (5) is defined between the permanent magnet outer rotor (4) and the stator (2);
a power output shaft (11), disposed in the stator (2);
thermal conductive cores (3), disposed on two ends of the stator (2), and the stator (2) being fixedly connected to the thermal conductive cores (3);
a metal bottom shell (10), disposed on the composite material shell (1); wherein the metal bottom shell (10) defines a water outlet (7) and a water inlet (8); and
a metal radiator (6), disposed in the metal bottom shell (10) and connected to the stator (2).

12. The composite material permanent magnet synchronous motor according to claim 11, wherein the stator comprises: a plurality of stator parts spaced apart from each other and surrounding the power output shaft (11).
